(19) United States
(12) Patent Application Publication
(10) Pub. No.: US 2026/0051521 A1
(43) Pub. Date: Feb. 19, 2026

(54) FUEL CELL SYSTEM

(71) Applicants: Hyundai Motor Company, Seoul (KR); Kia Corporation, Seoul (KR)

(72) Inventors: Sun Hee Jo, Suwon-si (KR); Ju Hae Jung, Uiwang-si (KR)

(21) Appl. No.: 18/808,192

(22) Filed: Aug. 19, 2024

(30) Foreign Application Priority Data
Mar. 12, 2024 (KR) 10-2024-0034565

(51) Int. Cl. H01M 8/04746; B08B 3/04; B08B 5/00; B08B 13/00; H01M 8/04119; H01M 8/04228; H01M 8/0444; H01M 8/06

(52) U.S. Cl. CPC H01M 8/04776; B08B 3/04; B08B 5/00; B08B 13/00; H01M 8/04141; H01M 8/04228; H01M 8/0444; H01M 8/06

(57) ABSTRACT

The present disclosure relates to a fuel cell system including a fuel cell stack, a humidifier configured to humidify air, which is to be supplied to the fuel cell stack, by means of moist air discharged from the fuel cell stack, a cleaning water supply line connected to the humidifier and configured to selectively supply cleaning water to the humidifier, and a cleaning water discharge line connected to the humidifier and configured to discharge the cleaning water to the outside of the humidifier, thereby obtaining an advantageous effect of improving durability and stability.

### CROSS-REFERENCE TO RELATED APPLICATION

This application claims priority to and the benefit of Korean Patent Application No. 10-2024-0034565 filed in the Korean Intellectual Property Office on Mar. 12, 2024, the entire contents of which are incorporated herein by reference.

### TECHNICAL FIELD

The present disclosure relates to a fuel cell system, and more particularly, to a fuel cell system capable of improving durability and stability.

### BACKGROUND

A fuel cell electric vehicle (FCEV) may produce electrical energy from an electrochemical reaction between oxygen and hydrogen in a fuel cell stack and travel by operating a motor.

The fuel cell electric vehicle may continuously generate electricity, regardless of a capacity of a battery, by being supplied with fuel (hydrogen) and air from the outside, and thus has high efficiency, and emits almost no contaminant. By virtue of these advantages, continuous research and development is being conducted on the fuel cell electric vehicle.

In general, the fuel cell electric vehicle may include a fuel cell stack configured to generate electricity by means of an oxidation-reduction reaction between hydrogen and oxygen, a fuel supply device configured to supply fuel (hydrogen) to the fuel cell stack, and an air supply device configured to supply the fuel cell stack with reaction air (oxygen) which is an oxidant required for an electrochemical reaction.

An electrolyte membrane of a membrane electrode assembly needs to be maintained at a predetermined humidity or higher in order to normally operate the fuel cell stack, and thus inflow gas introduced into the fuel cell stack may be humidified by a humidifier before being introduced into the fuel cell stack.

In at least some implementations, a method of humidifying inflow gas (dry air), which passes through the humidifier, by using moist air discharged from the fuel cell stack may be used.

Meanwhile, if a degree of internal contamination of the humidifier increases to a predetermined level or higher, the durability and stability of the humidifier and the fuel cell stack may be degraded. Therefore, it may be necessary to minimize the degree of internal contamination of the humidifier.

However, in the related art, when foreign substances (e.g., impurities or ions), which are contained in moist air discharged from the fuel cell stack, stagnate in the humidifier, there is a problem in that a humidification membrane is contaminated and damaged. In case that foreign substances remaining in the humidifier are introduced into the fuel cell stack, there is a problem in that the durability and stability of the fuel cell stack (e.g., the membrane electrode assembly and the separator) are degraded.

Therefore, various studies have been conducted to minimize the degree of internal contamination of the humidifier and improve the durability and stability, but the study results are still insufficient. Accordingly, there is a need to develop a technology to minimize the degree of internal contamination of the humidifier and improve the durability and stability.

### SUMMARY

The present disclosure has been made in an effort to provide a fuel cell system capable of improving durability and stability.

In particular, the present disclosure has been made in an effort to minimize contamination of and damage to a humidifier caused by foreign substances contained in moist air discharged from a fuel cell stack and minimize a degree to which foreign substances are introduced into the fuel cell stack.

Among other things, the present disclosure has been made in an effort to discharge foreign substances, which are introduced into the humidifier, to the outside of the humidifier in a timely manner.

The present disclosure has also been made in an effort to ensure operational efficiency of the humidifier and the fuel cell stack and ensure durability and stability of the humidifier and the fuel cell stack.

The present disclosure has also been made in an effort to improve the performance of the humidifier and the fuel cell stack and increase the lifespan of the humidifier and the fuel cell stack.

The objects to be achieved by the embodiment(s) are not limited to the above-mentioned objects, but also include objects or effects that may be understood from the solutions or embodiment(s) described below.

A fuel cell system may comprise: a fuel cell stack configured to discharge moist air; a humidifier configured to humidify, using the moist air discharged from the fuel cell stack, air, which is to be supplied to the fuel cell stack; a cleaning water supply line connected to the humidifier and configured to selectively supply cleaning water to the humidifier; and a cleaning water discharge line connected to the humidifier and configured to discharge the cleaning water from the humidifier.

The cleaning water supply line may selectively supply the cleaning water based on a degree of internal contamination of the humidifier. The fuel cell system may further comprises a e is configured to supply the cleaning water based on the degree of internal contamination of the humidifier being equal to or higher than a preset target contamination degree.

The fuel cell system may further comprise an alarm generator configured to generate an alarm signal based on the degree of internal contamination of the humidifier being higher than a preset target contamination degree. The humidifier may be configured to supply or discharge the cleaning water in a non-operation mode of the fuel cell stack in which an operation of the fuel cell stack is stopped. The humidifier may be configured to supply or discharge the cleaning water repeatedly based on a degree of internal contamination of the humidifier.

The humidifier may comprise a housing member having a humidification part configured to humidify air; a cleaning water supply port provided in the housing member and connected to the cleaning water supply line; and a cleaning water discharge port provided in the housing member and connected to the cleaning water discharge line.

The cleaning water supply port may be provided above the humidification part based on a gravitational direction. The cleaning water discharge port may be provided below the humidification part based on a gravitational direction.

The fuel cell system may further comprise an on-off valve provided in the cleaning water supply line and configured to selectively open or close the cleaning water supply line. The fuel cell system may further comprise an exhaust line connected to the humidifier and configured to discharge the moist air to an outside of the humidifier.

The humidifier may comprise a housing member and a humidification part configured to supply the humidified air into the fuel cell stack, wherein the housing member is configured to receive the cleaning water via the cleaning water supply line so that the cleaning water cleanses an exterior of the humidification part. The housing member may be configured to direct the cleaning water to flow from the cleaning water supply line toward the humidification part to clean impurities on the exterior of the humidification part.

A system may comprise: a humidifier configured to: humidify, using moist air discharged from a fuel cell stack, air received via at least one first openings; and supply, via at least one second openings, the humidified air to the fuel cell stack; a cleaning substance supply line connected to the humidifier and configured to selectively supply cleaning substance to the humidifier; and a cleaning substance discharge line connected to the humidifier and configured to discharge the cleaning substance from the humidifier.

The system may further comprise the fuel cell stack configured to discharge the moist air into the humidifier via a moist air injection line. The humidifier may comprise a housing member and a humidification part configured to supply the humidified air into the fuel cell stack, wherein the housing member is configured to receive the cleaning substance via the cleaning substance supply line so that the cleaning substance cleanses an exterior of the humidification part.

The housing member may be configured to direct the cleaning substance to flow from the cleaning substance supply line toward the humidification part to clean impurities on the exterior of the humidification part. The housing member may be configured to receive the cleaning substance via the cleaning substance supply line so that the cleaning substance cleanses an interior of the housing member.

The cleaning substance may comprises at least one of: cleaning liquid or cleaning gas.

### BRIEF DESCRIPTION OF THE DRAWINGS

FIG. 1 is a view for explaining a fuel cell system according to an embodiment of the present disclosure.

FIG. 2 is a view for explaining a humidifier of the fuel cell system according to the embodiment of the present disclosure.

FIG. 3 is a view for explaining a non-operation mode of a fuel cell stack of the fuel cell system according to the embodiment of the present disclosure.

FIG. 4 is a block diagram for explaining a method of controlling the fuel cell system according to the embodiment of the present disclosure.

### DETAILED DESCRIPTION

Hereinafter, various examples of the present disclosure will be described in detail with reference to the accompanying drawings.

However, the technical spirit of the present disclosure is not limited to the illustrated examples described herein but may be implemented in various different forms. One or more of the constituent elements in the embodiment(s) may be selectively combined and substituted for use within the scope of the technical spirit of the present disclosure.

In addition, unless otherwise specifically and explicitly defined and stated, the terms (including technical and scientific terms) used in the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the present disclosure are for explaining various features of the present disclosure, not for limiting the scope of the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected’, ‘coupled’, or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

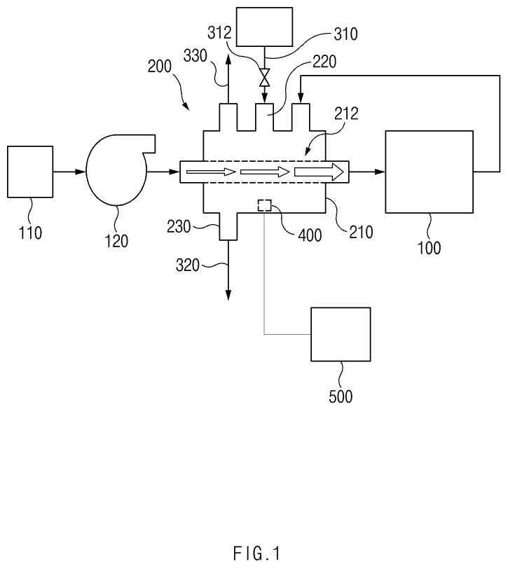

With reference to FIGS. 1 to 4, a fuel cell system 10 includes a fuel cell stack 100, a humidifier 200 configured to humidify air, which is to be supplied to the fuel cell stack 100, by means of moist air discharged from the fuel cell stack 100, a cleaning substance supply line 310 connected to the humidifier 200 and configured to selectively supply cleaning substance (e.g., cleaning liquid, such as cleaning water, and/or cleaning gas) to the humidifier 200, and a cleaning substance discharge line 320 connected to the humidifier 200 and configured to discharge the cleaning substance to the outside of the humidifier 200.

For reference, the fuel cell system 10 may be applied to various vehicles (e.g., passenger vehicles or commercial vehicles), ships, mobility vehicles in aerospace fields to which the fuel cell stack 100 may be applied. The present disclosure is not restricted or limited by the type and properties of an object (e.g., mobility vehicles) to which the fuel cell system 10 is applied.

The fuel cell stack 100 may refer to a kind of power generation device that generates electrical energy through a chemical reaction of fuel (e.g., hydrogen), and the fuel cell stack may be configured by stacking several tens or hundreds of fuel cells (unit cells) in series.

The fuel cell stack 100 may have various structures capable of producing electricity by means of an oxidation-reduction reaction between fuel (e.g., hydrogen) and an oxidant (e.g., air).

For example, the fuel cell stack 100 may include: a membrane electrode assembly (MEA) (not illustrated) having catalyst electrode layers in which electrochemical reactions occur and which are attached to two opposite sides of an electrolyte membrane through which hydrogen ions move; a gas diffusion layer (GDL) (not illustrated) configured to uniformly distribute reactant gases and transfer generated electrical energy; a gasket (not illustrated) and a fastener (not illustrated) configured to maintain leakproof sealability for the reactant gases and a coolant and maintain an appropriate fastening pressure; and a separator (bipolar plate) (not illustrated) configured to move the reactant gases and the coolant.

More specifically, in the fuel cell stack 100, hydrogen, which is fuel, and air (oxygen), which is an oxidant, are supplied to an anode and a cathode of the membrane electrode assembly, respectively, through flow paths in the separators, such that the hydrogen is supplied to the anode, and the air is supplied to the cathode.

The hydrogen supplied to the anode is decomposed into hydrogen ions (e.g., protons) and electrons by catalysts in the electrode layers provided at two opposite sides of the electrolyte membrane. Only the hydrogen ions may be selectively transmitted to the cathode through the electrolyte membrane, which is a cation exchange membrane, and at the same time, the electrons may be transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

Meanwhile, the electrolyte membrane of the membrane electrode assembly needs to be maintained at a predetermined humidity or higher so that the fuel cell stack 100 normally operates.

To this end, air, which may be supplied along an air supply line (not illustrated) via an air filter 110 and an air compressor 120, may pass through the humidifier 200, and air to be supplied to the fuel cell stack 100 along the air supply line may be humidified while passing through the humidifier 200. In this instance, the humidification of air may include a process of increasing the humidity of the air.

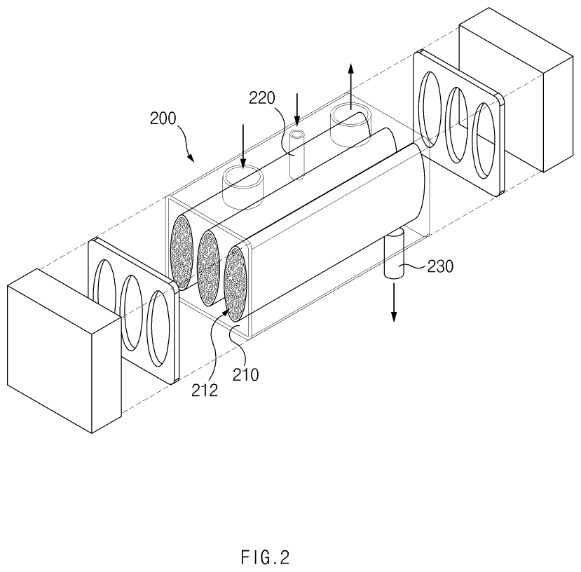

With reference to FIGS. 1 and 2, the humidifier 200 may be configured to humidify air (dry air) to be supplied to the fuel cell stack 100 by using air (e.g., moist air) discharged from the fuel cell stack 100.

The humidifier 200 may have various structures capable of humidifying the dry air by using the air (moist air) discharged from the fuel cell stack 100. Aspects of the present disclosure are not limited by the structure of the humidifier 200.

According to the present disclosure, the humidifier 200 may include a housing member 210 having a humidification part 212 configured to humidify air, a cleaning substance supply port 220 provided in the housing member 210 and connected to the cleaning substance supply line 310, and a cleaning substance discharge port 230 provided in the housing member 210 and connected to the cleaning substance discharge line 320.

In an example, the housing member 210 of the humidifier 200 may be equipped with an air supply port (not illustrated) into which air (e.g., dry air) is introduced (supplied), an air discharge port configured to discharge the air having passed through the humidification part 212 (to the fuel cell stack), a moist air supply port (not illustrated) into which moist air discharged from the fuel cell stack 100 is introduced, and a moist air discharge port (not illustrated) configured to discharge the moist air to the outside of the housing member 210.

The housing member 210 may be variously changed in shape and structure in accordance with required conditions and design specifications. Aspects of the present disclosure are not limited by the shape and structure of the housing member 210.

For example, the housing member 210 may include a housing main body (not illustrated), a first housing cap (not illustrated) connected to one end of the housing main body, and a second housing cap (not illustrated) connected to the other end of the housing main body.

For example, the housing main body may be provided (e.g., in the form of an approximately quadrangular box having the accommodation space therein). The first housing cap may be connected to a right end (based on FIG. 2) of the housing main body, and the second housing cap may be connected to a left end (based on FIG. 2) of the housing main body.

According to another aspect of the present disclosure, the first housing cap and the second housing cap may be provided at an upper or lower end of the housing main body.

The humidification part 212 may be provided in the housing member 210 to humidify air by using the moist air supplied to the housing member 210.

The humidification part 212 may have various structures capable of humidifying the air by using the moist air. Aspects of the present disclosure are not limited by the structure of the humidification part 212.

For example, the humidification part 212 may include a cartridge casing (not illustrated) provided in the housing member 210 and having, at one side thereof, a first through portion (not illustrated) through which the moist air is introduced, and having, at the other side thereof, a second through portion (not illustrated) through which the moist air is discharged, and a humidification membrane (not illustrated) provided in the cartridge casing and configured to allow air to move along the humidification membrane.

The cartridge casing may have various structures having therein an accommodation space. Aspects of the present disclosure are not limited by the structure of the cartridge casing.

For reference, the number of cartridge casings and the arrangement of the cartridge casing may be variously changed in accordance with required conditions and design specifications. For example, a plurality of cartridge casings may be disposed in parallel in the housing member 210. According to another aspect of the present disclosure, only a single cartridge casing may be provided in the housing.

The humidification membrane may be provided in the cartridge casing and configured such that the air moves along the inside of the humidification membrane.

For example, the humidification membrane is provided in the form of a tubular hollow fiber membrane along which air may move. One end (e.g., an inlet end) and the other end (e.g., an outlet end) of the humidification membrane may be fixed in the cartridge casing by a potting material.

For reference, because the humidification membrane is provided in the form of a hollow fiber membrane, the moisture (e.g., the moisture in the moist air) supplied into the cartridge casing may penetrate into the humidification membrane from the outside of the humidification membrane and then be transferred to the air. However, the air cannot penetrate the humidification membrane from the inside of the humidification membrane to the outside of the humidification membrane.

With the above-mentioned structure, the air, which is introduced through the air supply port of the housing member 210, may be humidified by the moist air while passing through the humidification part 212 provided in the housing member 210. The air (humidified air), which is discharged through the air discharge port, may be supplied to the fuel cell stack 100.

Further, the moist air (or produced water), which is discharged from the fuel cell stack 100 and supplied to the housing member 210 via the moist air supply port, may be supplied into the cartridge casing through the first through portion. The moist air, which is supplied into the cartridge casing, may flow along a periphery of the humidification membrane and humidify the air moving along the humidification membrane. Thereafter, the moist air, which is discharged to the outside of the cartridge casing through the second through portion, may be discharged to the outside of the housing member 210 through the moist air discharge port.

For reference, with respect to the various aspects of the present disclosure described and illustrated above, the example has been described in which the humidification membrane is disposed in the cartridge casing. However, according to another aspect of the present disclosure, the humidification membrane may be directly disposed in the housing member without separately providing the cartridge casing.

The cleaning substance supply line 310 may be connected to the cleaning substance supply port 220 to selectively supply the cleaning substance to the humidifier 200.

In the present disclosure, the cleaning substance may be a cleaning medium for cleaning foreign substances (e.g., impurities or ions) introduced into the humidifier 200 (particularly, the periphery of the humidification membrane). Aspects of the present disclosure are not limited by the type and properties of the cleaning substance.

For example, typical deionized water may be used as the cleaning substance.

The cleaning substance supply line 310 may have various structures in accordance with required conditions and design specifications. Aspects of the present disclosure are not limited by the structure and shape of the cleaning substance supply line 310.

For example, the cleaning substance supply line 310 may be provided in the form of an approximately straight tube that connects a cleaning substance storage (not illustrated) and the humidifier 200. Alternatively or additionally, at least part of the cleaning substance supply line may have a curved shape or other shapes.

The cleaning substance supply line 310 may be connected to various portions of the housing member 210 in accordance with required conditions and design specifications. Aspects of the present disclosure are not limited by the position to which the cleaning substance supply line 310 is connected.

In particular, the cleaning substance supply port 220 may be provided above the humidification part 212 based on the gravitational direction. More particularly, the cleaning substance supply port 220 may be connected to an uppermost portion of the housing member 210.

Because the cleaning substance supply port 220 is provided at an upper side of the housing member 210 (e.g., provided above the humidification part 212) as described above, the cleaning substance may be dropped in the gravitational direction by the weight of the cleaning substance and clean the humidification membrane without a separate spray device for forcibly spraying the cleaning substance, which is supplied to the cleaning substance supply port 220, toward the humidification membrane. Therefore, it is possible to obtain an advantageous effect of simplifying the structure and improving the degree of design freedom and the spatial utilization.

According to the present disclosure, the fuel cell system 10 may include an on-off valve 312 provided in the cleaning substance supply line 310 and configured to selectively open or close the cleaning substance supply line 310.

A typical valve (e.g., a solenoid valve) capable of opening or closing the cleaning substance supply line 310 (e.g., regulating the supply of the cleaning substance) may be used as the on-off valve 312. Aspects of the present disclosure are not limited by the type and structure of the on-off valve 312.

The cleaning substance discharge line 320 is provided to discharge the cleaning substance, which has cleaned the inside of the humidifier 200, to the outside of the humidifier 200.

The cleaning substance discharge line 320 may have various structures in accordance with required conditions and design specifications. Aspects of the present disclosure are not limited by the structure and shape of the cleaning substance discharge line 320.

For example, the cleaning substance discharge line 320 may have an approximately straight shape. Alternatively or additionally, the cleaning substance discharge line may have a curved shape or other shapes.

The cleaning substance discharge line 320 may be connected to various portions of the housing member 210 in accordance with required conditions and design specifications. Aspects of the present disclosure are not limited by the position to which the cleaning substance discharge line 320 is connected.

In particular, the cleaning substance discharge port 230 may be provided below the humidification part 212 based on the gravitational direction. More particularly, the cleaning substance discharge port 230 may be connected to a lowermost portion of the housing member 210.

Because the cleaning substance discharge port 230 is provided at a lower side of the housing member 210 (provided below the humidification part 212) as described above, the cleaning substance may be discharged without a separate discharge device (e.g., a pump) for discharging the cleaning substance, which is supplied to the cleaning substance discharge port 230, to the outside of the housing member 210. Therefore, it is possible to obtain an advantageous effect of simplifying the structure and improving the degree of design freedom and the spatial utilization.

According to one or more aspects of the present disclosure, the fuel cell system 10 may include an exhaust line 330 connected to the humidifier 200 to discharge the moist air to the outside of the humidifier 200.

The exhaust line 330 may have various structures capable of discharging the moist air to the outside of the housing member 210. Aspects of the present disclosure are not limited by the structure and shape of the exhaust line 330.

For example, the exhaust line 330 may have an approximately straight shape and be connected to an upper portion of the housing member 210.

Meanwhile, a time point at which the cleaning substance is supplied through the cleaning substance supply line 310 may be variously changed in accordance with required conditions and design specifications. Aspects of the present disclosure are not limited by the time point at which the cleaning substance is supplied.

According to the present disclosure, the cleaning substance supply line 310 may be configured to selectively supply the cleaning substance on the basis of a degree of internal contamination of the humidifier 200.

According to one or more aspects of the present disclosure, the fuel cell system 10 may include a contamination degree measurement sensor 400 provided in the humidifier 200 and configured to sense the degree of internal contamination of the humidifier 200. The cleaning substance supply line 310 may be configured to supply the cleaning substance when the degree of internal contamination of the humidifier 200 is higher than a preset target contamination degree.

In particular, the target contamination degree(s) of the humidifier 200 may be stored (e.g., in advance in a lookup table) for respective operating conditions of the fuel cell stack 100. Whether to supply the cleaning substance may be quickly controlled by comparing information (e.g., target contamination degree) stored in advance in the lookup table with the degree of internal contamination (e.g., expressed as a measurement value) of the humidifier 200.

For example, if it is determined that the degree of internal contamination of the humidifier 200 is higher than the target contamination degree, the on-off valve 312 may be controlled to supply the cleaning substance into the housing member 210.

Further, control parameters, which are not stored in advance in the lookup table, may be calculated by interpolation using information on errors in the adjacent values stored in advance.

Various sensors capable of measuring the degree of internal contamination of the humidifier 200 may be used as the contamination degree measurement sensor 400. Aspects of the present disclosure are not limited by the type and structure of the contamination degree measurement sensor 400.

For example, an ion sensor (e.g., an ion meter) capable of sensing, in real time, an ion concentration of the cleaning substance discharged from the housing member 210 may be used as the contamination degree measurement sensor 400. The degree of internal contamination of the humidifier 200 may be measured on the basis of the result (e.g., ion concentration) sensed by the ion sensor.

According to one or more aspects of the present disclosure, the fuel cell system 10 may include an alarm generation part 500 configured to generate an alarm signal when the degree of internal contamination of the humidifier 200 is higher than the preset target contamination degree.

In this case, the alarm signal may include at least one of an auditory alarm signal made by a typical sound generator and a visual alarm signal made by a typical warning lamp. Other various alarm signals may be used to inform an operator (user) of a situation in which the degree of internal contamination of the humidifier 200 is higher than the target contamination degree.

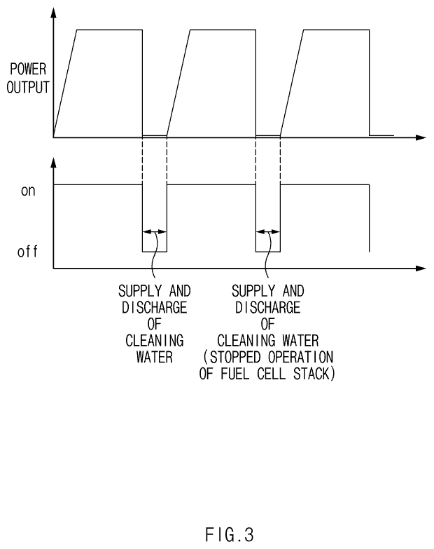

With reference to FIG. 3, the process of supplying and discharging the cleaning substance may be performed in a non-operation mode of the fuel cell stack 100 in which the operation of the fuel cell stack 100 is stopped.

For example, after the fuel cell stack 100 operates for a preset target operating time, the fuel cell stack 100 may switch to the non-operation mode (rest mode) in which the operation is stopped for a preset time. The process of supplying and discharging the cleaning substance may be performed in the non-operation mode of the fuel cell stack 100.

More particularly, the process of supplying and discharging the cleaning substance may be repeatedly performed on the basis of the degree of internal contamination of the humidifier 200.

In an example, the process of supplying and discharging the cleaning substance may be repeatedly performed in the non-operation mode on the basis of the degree of internal contamination of the humidifier 200.

The target operating time of the fuel cell stack 100 may be shortened by an automatic or manual process when it is determined that the degree of internal contamination of the humidifier 200 is higher than the preset target contamination degree. Alternatively and/or additionally, the time of the non-operation mode of the fuel cell stack may be adjusted (e.g., extended) on the basis of the degree of internal contamination of the humidifier.

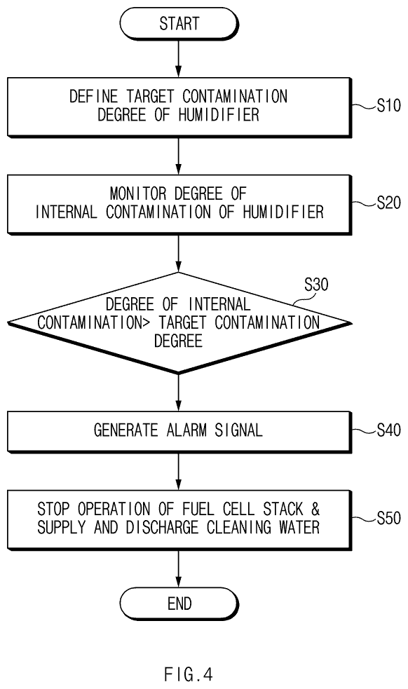

Meanwhile, FIG. 4 is a block diagram for explaining a method of controlling the fuel cell system. Further, the parts identical and equivalent to the parts in the above-mentioned configuration will be designated by the identical or equivalent reference numerals, and detailed descriptions thereof will be omitted.

With reference to FIG. 4, the method of controlling the fuel cell system may include step S10 of defining the target contamination degree of the humidifier 200, step S20 of monitoring the degree of internal contamination of the humidifier 200, step S30 of comparing the degree of internal contamination (measurement value) and the target contamination degree, step S40 of generating the alarm signal when the degree of internal contamination is higher than the target contamination degree, and step S50 of stopping the operation of the fuel cell stack 100 and cleaning the inside of the humidifier 200 by supplying and discharging the cleaning substance.

The target contamination degree of the humidifier 200 is defined (S10). For example, in step S10 of defining the target contamination degree of the humidifier 200, a critical value of the amount of contaminants for a cleaning cycle alarm may be defined, and the number of cleaning times according to the amount of contaminants may be defined.

The degree of internal contamination of the humidifier 200 may be monitored (S20). For example, the degree of internal contamination of the humidifier 200 may be monitored by sensing, in real time, the contamination degree (e.g., ion concentration) of the cleaning substance discharged from the humidifier 200.

Whether the degree of internal contamination (e.g., expressed as a measurement value) of the humidifier 200 is higher than the preset target contamination degree may be determined (S30). In case that the degree of internal contamination (e.g., expressed as a measurement value) of the humidifier 200 is higher than the preset target contamination degree, the alarm signal may be generated (S40), and the cleaning substance may be supplied to and discharged from the humidifier 200 in the non-operation mode (rest mode) in which the operation of the fuel cell stack 100 is stopped (S50), such that the inside of the humidifier 200 may be cleaned.

In order to achieve the above-mentioned objects, an exemplary embodiment of the present disclosure provides a fuel cell system including: a fuel cell stack; a humidifier configured to humidify air, which is to be supplied to the fuel cell stack, by means of moist air discharged from the fuel cell stack; a cleaning substance supply line connected to the humidifier and configured to selectively supply cleaning substance to the humidifier; and a cleaning substance discharge line connected to the humidifier and configured to discharge the cleaning substance to the outside of the humidifier.

This is to improve durability and stability of the fuel cell system.

That is, in the related art, when foreign substances (e.g., impurities or ions), which are contained in moist air discharged from the fuel cell stack, stagnate in the humidifier, there is a problem in that a humidification membrane is contaminated and damaged. In case that foreign substances remaining in the humidifier are introduced into the fuel cell stack, there is a problem in that the durability and stability of the fuel cell stack (e.g., the membrane electrode assembly and the separator) are degraded.

However, according to the embodiment of the present disclosure, the cleaning substance supply line configured to supply the cleaning substance to the humidifier is provided, and the cleaning substance discharge line configured to discharge the cleaning substance to the outside of the humidifier is provided, such that the inside of the humidifier may be cleaned by the cleaning substance. Therefore, it is possible to obtain an advantageous effect of improving the durability and stability.

Among other things, according to the embodiment of the present disclosure, the inside of the humidifier may be cleaned by supplying the cleaning substance to the humidifier. Therefore, it is possible to obtain an advantageous effect of minimizing contamination of and damage to the humidifier caused by foreign substances contained in the moist air discharged from the fuel cell stack and minimizing the degree to which the foreign substances are introduced into the fuel cell stack.

The humidifier may have various structures capable of humidifying dry air by using moist air discharged from the fuel cell stack.

According to the exemplary embodiment of the present disclosure, the humidifier may include: a housing member having a humidification part configured to humidify air; a cleaning substance supply port provided in the housing member and connected to the cleaning substance supply line; and a cleaning substance discharge port provided in the housing member and connected to the cleaning substance discharge line.

The cleaning substance supply line may be connected to various portions of the housing member in accordance with required conditions and design specifications.

According to the exemplary embodiment of the present disclosure, the cleaning substance supply port may be provided above the humidification part based on a gravitational direction.

Because the cleaning substance supply port is provided at an upper side of the housing member (provided above the humidification part) as described above, the cleaning substance may be dropped in the gravitational direction by the weight of the cleaning substance and clean the humidification membrane without a separate spray device for forcibly spraying the cleaning substance, which is supplied to the cleaning substance supply port, toward the humidification membrane. Therefore, it is possible to obtain an advantageous effect of simplifying the structure and improving the degree of design freedom and the spatial utilization.

According to the exemplary embodiment of the present disclosure, the fuel cell system may include an on-off valve provided in the cleaning substance supply line and configured to selectively open or close the cleaning substance supply line.

The cleaning substance discharge line may be connected to various portions of the housing member in accordance with required conditions and design specifications.

According to the exemplary embodiment of the present disclosure, the cleaning substance discharge port may be provided below the humidification part based on a gravitational direction.

Because the cleaning substance discharge port is provided at a lower side of the housing member (provided below the humidification part) as described above, the cleaning substance may be discharged without a separate discharge device for discharging the cleaning substance, which is supplied to the cleaning substance discharge port, to the outside of the housing member. Therefore, it is possible to obtain an advantageous effect of simplifying the structure and improving the degree of design freedom and the spatial utilization.

In addition, according to the exemplary embodiment of the present disclosure, the fuel cell system may include an exhaust line connected to the humidifier and configured to discharge the moist air to the outside of the humidifier.

The time point at which the cleaning substance is supplied through the cleaning substance supply line may be variously changed in accordance with required conditions and design specifications.

According to the exemplary embodiment of the present disclosure, the cleaning substance supply line may be configured to selectively supply the cleaning substance on the basis of a degree of internal contamination of the humidifier.

According to the exemplary embodiment of the present disclosure, the fuel cell system may include a contamination degree measurement sensor provided in the humidifier and configured to sense the degree of internal contamination of the humidifier. The cleaning substance supply line may be configured to supply the cleaning substance when the degree of internal contamination of the humidifier is higher than a preset target contamination degree.

According to the exemplary embodiment of the present disclosure, the fuel cell system may include an alarm generation part configured to generate an alarm signal when the degree of internal contamination of the humidifier is higher than the preset target contamination degree.

In this case, the alarm signal may include at least one of an auditory alarm signal made by a typical sound means and a visual alarm signal made by a typical warning lamp. In addition, other various alarm signals may be used to inform an operator (user) of a situation in which the degree of internal contamination of the humidifier is higher than the target contamination degree.

According to the exemplary embodiment of the present disclosure, the process of supplying and discharging the cleaning substance may be performed in a non-operation mode of the fuel cell stack in which the operation of the fuel cell stack is stopped.

More particularly, the process of supplying and discharging the cleaning substance may be repeatedly performed on the basis of the degree of internal contamination of the humidifier.

According to one or more aspects of the present disclosure described above, it is possible to obtain an advantageous effect of improving the durability and stability.

In particular, according to one or more aspects of the present disclosure, it is possible to obtain an advantageous effect of minimizing contamination of and damage to the humidifier caused by foreign substances contained in the moist air discharged from the fuel cell stack and minimizing the degree to which the foreign substances are introduced into the fuel cell stack.

Among other things, according to one or more aspects of the present disclosure, it is possible to obtain an advantageous effect of discharging foreign substances, which are introduced into the humidifier, to the outside of the humidifier in a timely manner.

In addition, according to one or more aspects of the present disclosure, it is possible to obtain an advantageous effect of ensuring the operational efficiency of the humidifier and the fuel cell stack and ensuring the durability and stability of the humidifier and the fuel cell stack.

In addition, according to one or more aspects of the present disclosure, it is possible to obtain an advantageous effect of improving the performance of the humidifier and the fuel cell stack and increasing the lifespan of the humidifier and the fuel cell stack.

While various examples have been described above, the described features are just illustrative and not intended to limit the present disclosure. It can be appreciated by those skilled in the art that various modifications and applications, which are not described above, may be made to the present embodiment without departing from the intrinsic features of the present embodiment. For example, the respective constituent elements specifically described in the disclosure may be modified and then carried out. Further, it should be interpreted that the differences related to the modifications and applications are included in the scope of the present disclosure defined by the appended claims.

What is claimed is:

1. A fuel cell system comprising:
a fuel cell stack configured to discharge moist air;
a humidifier configured to humidify, using the moist air discharged from the fuel cell stack, air, which is to be supplied to the fuel cell stack;
a cleaning water supply line connected to the humidifier and configured to selectively supply cleaning water to the humidifier; and
a cleaning water discharge line connected to the humidifier and configured to discharge the cleaning water from the humidifier.

2. The fuel cell system of claim 1, wherein the cleaning water supply line selectively supplies the cleaning water based on a degree of internal contamination of the humidifier.

3. The fuel cell system of claim 2, further comprising:
a contamination degree measurement sensor provided in the humidifier and configured to sense the degree of internal contamination of the humidifier,
wherein the cleaning water supply line is configured to supply the cleaning water based on the degree of internal contamination of the humidifier being equal to or higher than a preset target contamination degree.

4. The fuel cell system of claim 2, further comprising:
an alarm generator configured to generate an alarm signal based on the degree of internal contamination of the humidifier being higher than a preset target contamination degree.

5. The fuel cell system of claim 1, wherein the humidifier is configured to supply or discharge the cleaning water in a non-operation mode of the fuel cell stack in which an operation of the fuel cell stack is stopped.

6. The fuel cell system of claim 1, wherein the humidifier is configured to supply or discharge the cleaning water repeatedly based on a degree of internal contamination of the humidifier.

7. The fuel cell system of claim 1, wherein the humidifier comprises:
a housing member having a humidification part configured to humidify air;
a cleaning water supply port provided in the housing member and connected to the cleaning water supply line; and
a cleaning water discharge port provided in the housing member and connected to the cleaning water discharge line.

8. The fuel cell system of claim 7, wherein the cleaning water supply port is provided above the humidification part based on a gravitational direction.

9. The fuel cell system of claim 7, wherein the cleaning water discharge port is provided below the humidification part based on a gravitational direction.

10. The fuel cell system of claim 1, further comprising:
an on-off valve provided in the cleaning water supply line and configured to selectively open or close the cleaning water supply line.

11. The fuel cell system of claim 1, further comprising:
an exhaust line connected to the humidifier and configured to discharge the moist air to an outside of the humidifier.

12. The fuel cell system of claim 1, wherein the humidifier comprises:
a housing member; and
a humidification part configured to supply the humidified air into the fuel cell stack,
wherein the housing member is configured to receive the cleaning water via the cleaning water supply line so that the cleaning water cleanses an exterior of the humidification part.

13. The fuel cell system of claim 12, wherein the housing member is configured to direct the cleaning water to flow from the cleaning water supply line toward the humidification part to clean impurities on the exterior of the humidification part.

14. The fuel cell system of claim 12, wherein the housing member is configured to receive the cleaning water via the cleaning water supply line so that the cleaning water cleanses an interior of the housing member.

15. A system comprising:
a humidifier configured to:
humidify, using moist air discharged from a fuel cell stack, air received via at least one first openings; and
supply, via at least one second openings, the humidified air to the fuel cell stack;
a cleaning substance supply line connected to the humidifier and configured to selectively supply cleaning substance to the humidifier; and
a cleaning substance discharge line connected to the humidifier and configured to discharge the cleaning substance from the humidifier.

16. The system of claim 15, further comprising the fuel cell stack configured to discharge the moist air into the humidifier via a moist air injection line.

17. The system of claim 15, wherein the humidifier comprises:
a housing member; and
a humidification part configured to supply the humidified air into the fuel cell stack,
wherein the housing member is configured to receive the cleaning substance via the cleaning substance supply line so that the cleaning substance cleanses an exterior of the humidification part.

18. The system of claim 17, wherein the housing member is configured to direct the cleaning substance to flow from the cleaning substance supply line toward the humidification part to clean impurities on the exterior of the humidification part.

19. The system of claim 17, wherein the housing member is configured to receive the cleaning substance via the cleaning substance supply line so that the cleaning substance cleanses an interior of the housing member.

20. The system of claim 15, wherein the cleaning substance comprises at least one of:
cleaning liquid; or
cleaning gas.
